(19) United States
(12) Patent Application Publication
(10) Pub. No.: US 2022/0113718 A1
(43) Pub. Date: Apr. 14, 2022

(54) CABINET WITH FILTER LIFE PREDICTION AND METHOD OF PREDICTING FILTER LIFE

(71) Applicant: DELTA ELECTRONICS, INC., Taoyuan City (TW)

(72) Inventors: Ren-Chun CHANG, Taoyuan City (TW); Shao-Li CHIU, Taoyuan City (TW)

(21) Appl. No.: 17/238,830

(22) Filed: Apr. 23, 2021

(30) Foreign Application Priority Data
Oct. 13, 2020 (CN) 202011089435.X

(51) Int. Cl. G05B 23/02

(52) U.S. Cl. CPC G05B 23/0283; G05B 23/024

(57) ABSTRACT

A cabinet with filter life prediction function and a method of predicting filter life are provided. The cabinet has an airflow module generating airflow flowing through a filter module. An air quality sensor continuously monitors the air quality sensing value of the airflow and records the sensed value in association with the sensing time. A regression analysis is performed based on the record data to obtain a regression model when a modeling condition is met. When a prediction condition is met, a time period for the currently sensed value to decrease to a threshold is calculated to be a predicted remaining life of the filter module. A notification is generated when the predicted remaining life of the filter module is less than a life threshold.

### BACKGROUND OF THE INVENTION

### Field of the Invention

The technical field relates to filter life, and more particularly relates to filter life prediction.

### Description of Related Art

Air purification devices in the related art determine whether the filter life reaches the end through following conventional methods.

One method is determining whether the filter life reaches the end by monitoring either the difference between the upstream pressure and downstream pressure of the filter or the downstream temperature of the filter in real time. The above method may lead to misjudgment due to interference of the environmental variations and cannot predict the remaining life of the filter.

Another method is setting a timer to count a designated period of time as a default time for replacing the filter, such as three months, and providing a notification when the time interval expires. The above method may cause the filter to be replaced too early or too late, reducing the quality of air purification and raising the operating costs. Besides, the above method is also unable to predict the remaining life of the filter.

The above-mentioned methods are unable to predict the remaining life of the filter based on the environment where the device is located, such that users may not be able to prepare to replace the filter in advance, which may lead to an interruption in air purification during the period from the end of life of the old filter to the replacement of the new filter.

### SUMMARY OF THE INVENTION

The disclosure provides a cabinet with filter life prediction function and a method of predicting filter life able to predict the remaining life of the filter currently used and proactively provide a notification of filter replacement before the filter life reaches the end.

In one of the exemplary embodiments, a method of predicting filter life is provided. The method includes the following steps: a) operating an airflow generation module to generate an airflow to flow through a filter module; b) monitoring the airflow by an air quality sensing module to obtain an air quality sensing value, and recording the air quality sensing value and a corresponding sensing time as record data; c) performing, when a modeling condition is met, a regression analysis by a control module based on the record data to obtain a regression model; d) calculating, when a prediction condition is met, a time period for the air quality sensing value to reach an air quality threshold based on the regression model as a predicted remaining life; and e) generating a notification when the predicted remaining life is less than a life threshold.

In one of the exemplary embodiments, a cabinet with filter life prediction function is provided. The cabinet includes a cabinet body, a filter module, an airflow generation module, an air quality sensing module and a control module. The cabinet body includes an accommodation space and an opening communicating with the accommodation space. The filter module is disposed at the opening. The airflow generation module generates an airflow to flow through the opening, the filter module, and the accommodation space. The air quality sensing module is disposed downstream from the filter module and configured to continuously sense an air quality sensing value of the airflow. The control module is electrically connected to the airflow generation module and configured to control the airflow generation module, and the control module is electrically connected to the air quality sensing module and configured to record the air quality sensing value and a corresponding sensing time as record data, perform a regression analysis based on the record data to obtain a regression model when a modeling condition is met, calculate a time period for the air quality sensing value to reach an air quality threshold as a predicted remaining life based on the regression model when a prediction condition is met, and generate a notification when the predicted remaining life is less than a life threshold.

The disclosure is able to predict the remaining life of the filter accurately, and notify users in advance to prepare to replace the currently used filter before the end of the filter life, so as to keep the air purification in a better state.

### BRIEF DESCRIPTION OF DRAWINGS

The features of the disclosure are believed to be novel are set forth with particularity in the appended claims. The disclosure itself, however, may be best understood by reference to the following detailed description of the disclosure which describes an exemplary embodiment of the present disclosed example, taken in conjunction with the accompanying drawings, in which:

FIG. 1 is an architecture diagram of an air purification system according to the first embodiment of the disclosure;

FIG. 2 is an architecture diagram of an air purification system according to the second embodiment of the disclosure;

FIG. 3 is an arrangement diagram of a cabinet according to the third embodiment of the disclosure;

FIG. 4 is an architecture diagram of a prediction module according to the fourth embodiment of the disclosure;

FIG. 5 is a flowchart of a method of predicting filter life according to the first embodiment of the disclosure;

FIG. 6 is a partial flowchart of a method of predicting filter life according to the second embodiment of the disclosure;

FIG. 7A is the first part of a flowchart of a method of predicting filter life according to the third embodiment of the disclosure;

FIG. 7B is the second part of the flowchart of the method of predicting filter life according to the third embodiment of the disclosure;

FIG. 8 is a partial flowchart of a method of predicting filter life according to the fourth embodiment of the disclosure;

FIG. 9 is an exemplary regression analysis chart of the filtration capacity according to one example of the disclosure;

FIG. 10 is an exemplary regression analysis chart of the filtration capacity according to one example of the disclosure;

FIG. 11 is an exemplary regression analysis chart of the filtration capacity according to one example of the disclosure;

FIG. 12 an exemplary regression analysis chart of the filtration capacity according to one example of the disclosure;

FIG. 13 is a schematic view of one type of regression analysis according to one example of the disclosure;

FIG. 14 is a schematic view of another type of regression analysis according to one example of the disclosure; and

FIG. 15 is a schematic view of another type of regression analysis according to one example of the disclosure.

### DETAILED DESCRIPTION OF THE INVENTION

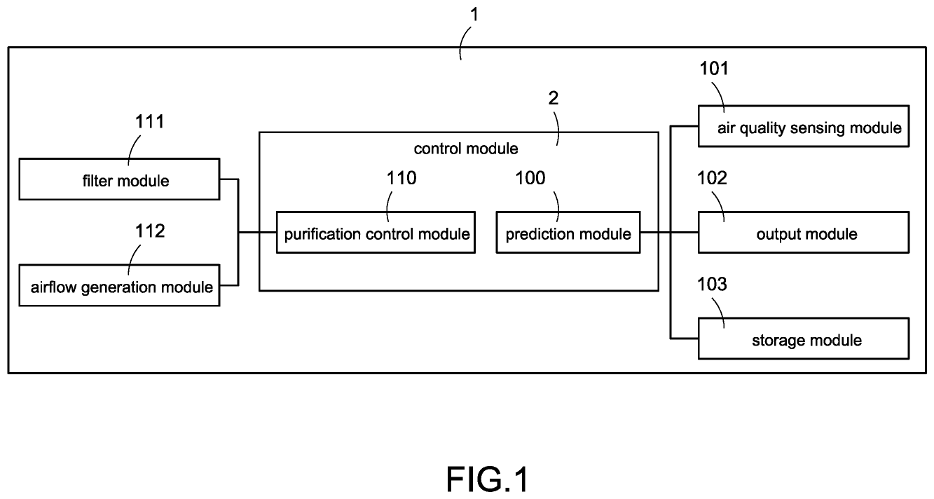

FIG. 1 illustrates an exemplary air purification system having the ability to purify the ambient air, predict the remaining life of the filter, and notify users to prepare to replace the currently used filter before the filter life reaches the end.

The air purification system 1 may include a filter module 111, an airflow generation module 112, and a control module 2 electrically connected to the airflow generation module 112. The filter module 111, the airflow generation module 112 and the control module 2 work collaboratively to purify the ambient air.

The airflow generation module 112 generates an airflow to flow through the filter module 111. The filter module 111 filters out the impurities in the airflow, such as particulate matters bigger than a specific size or specific chemical molecules, to purify the airflow. The control module 2, which may include one or more processor(s), controller(s), SoC, other control modules or any combination of the above modules, controls the operation of the airflow generation module 112, such as on/off status, airflow direction, and/or fan speed.

The air purification system 1 further includes an air quality sensing module 101 and a storage module 103. The air quality sensing module 101 is electrically connected to the control module 2 to co-work to predict the remaining life of the filter and generates a notification to users accordingly.

The air quality sensing module 101 is disposed downstream from the filter module 111, and senses an air quality sensing value of the airflow flowing through the filter module 111. The storage module 103 stores the sensing data. The control module 2 continuously retrieves the air quality sensing value and makes record data by associating the air quality sensing value with the corresponding sensing time. The control module 2 may further executes the filter life prediction of the disclosure (described below).

The air purification system 1 may further include an output module 102 electrically connected to the control module 2 to output the notifications.

The control module 2 may include a purification control module 110 and a prediction module 100, such as a processor, a controller or a SoC (system on chip). The purification control module 110 is electrically connected to the airflow generation module 112 and controls the airflow generation module 112. The prediction module 100 is electrically connected to the air quality sensing module 101, the output module 102 and the storage module 103, and configured to implement the filter life prediction of the disclosure.

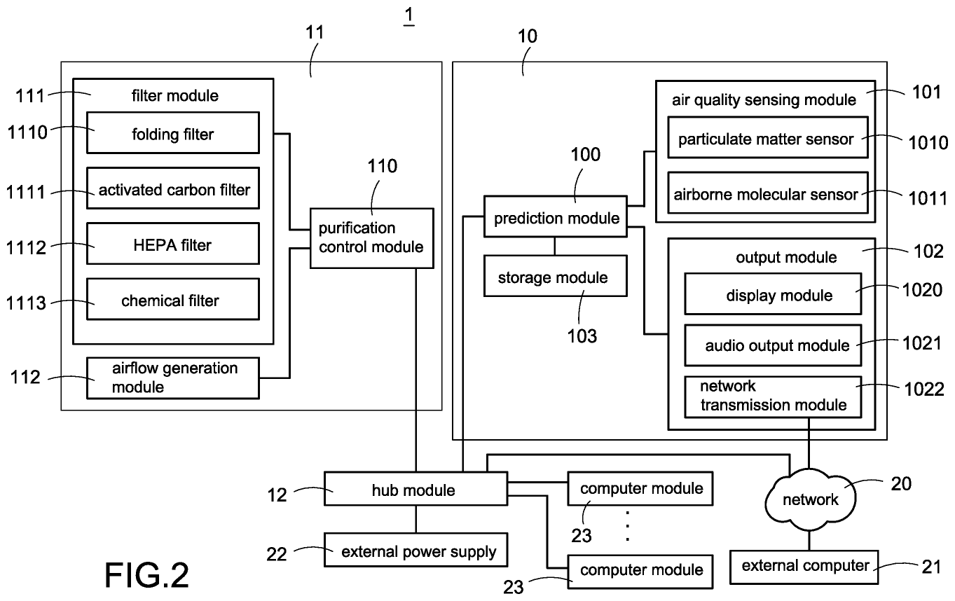

FIG. 2 illustrates another exemplary air purification system 1 includes an air purification device 11 and a prediction device 10.

The air purification device 11 includes a filter module 111, an airflow generation module 112 and a purification control module 110. The prediction device 10 includes an air quality sensing module 101, an output module 102, a storage module 103 and a prediction module 100.

The filter module 111 may include at least one of the following filters: a folding filter 1110, an activated carbon filter 1111, a HEPA (High-Efficiency Particulate Air) filter 1112, and a chemical filter 1113. In one embodiment, only one type of the filters may be used, or in another embodiment, multiple types of the filters may be arranged layer by layer, for example, the filter with larger fiber voids or longer filter life may be located at the outer layer near the upstream, and the filter with smaller fiber voids or shorter filter life may be located at the inner layer near the downstream. The folding filter 1110, the activated carbon filter 1111 and the HEPA filter 1112 have relatively smaller fiber voids and can filter the particulate matter. Different levels of filters have different levels of filtration capacity. In other words, filters with different sizes of fiber voids can filter different sizes of particulate matters, such as PM 2.5, PM 10 and so forth. The chemical filter 1113 is made by the chemical media, and is able to adsorb and filter out the pollutant molecules in the airflow. Therefore, according to the disclosure, different levels of filtration capacity may be implemented by arranging different levels of filters according to actual user needs.

The air quality sensing module 101 may include at least one of a particulate matter sensor 1010 and an airborne molecular sensor 1011. The particulate matter sensor 1010 and the airborne molecular sensor 1011 are disposed downstream from the filter module 111. The user may set up multiple particulate matter sensors 1010 of different levels according to his requirement, such as PM 2.5 sensor and PM 10 sensor.

The type of air quality sensing module 101 to be set up should match the type of the filter module 111 to be set up. For example, if a PM 10 filter or a PM 2.5 filter is to be set up, a PM 10 sensor or a PM 2.5 sensor (namely, the particulate matter sensor 1010) should be set up correspondingly. In another example, when a chemical filter used to filter acids, bases, condensables or dopants is to be set up, a sensor (namely, the chemical filter 1011) used to sense the concentration of the acids, bases, condensables or dopants should be set up correspondingly.

The output module 102 may include at least one of a display module 1020, an audio output module 1021 and a network transmission module 1022. The prediction module 100 may convert the notification content into images, such as graphics or text messages, and display the images on the display module 1022, such as a monitor. The prediction module 100 may convert the notification content into audio, and control the audio output module 1021 to play it.

The network transmission module 1022 may be connected to an external computer 21, such as a remote management host or a user's mobile device, notebook or other computer apparatuses, through a network 20, such as the internet. The prediction module 100 may convert the notification content into messages, such as data packages, and transmit the messages to the external computer 21 through the network 20 to notify the user.

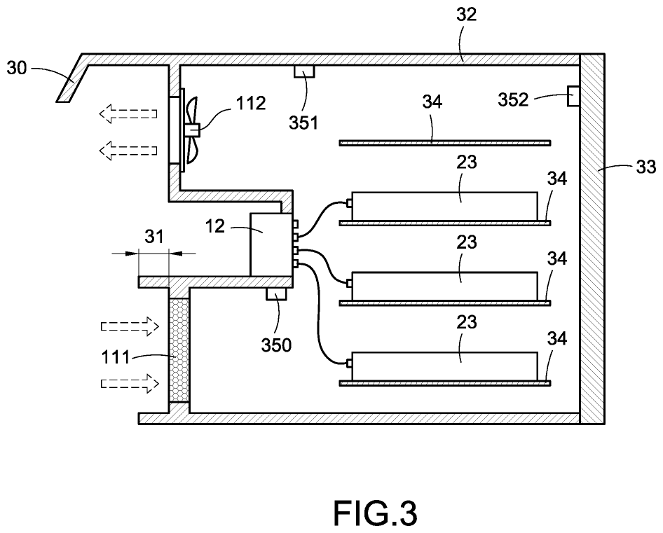

FIG. 3 illustrates an exemplary air purification system 1, which may be a cabinet with air purification and filter life prediction functions.

The cabinet may include a cabinet body 32 which may have a cabinet door 33. The cabinet includes an accommodation space and one or multiple openings communicating with the accommodation space. A filter module 111 is disposed at the air inlet opening. The airflow generation module 112 and the filter module 111 may be disposed at the same opening or different opening.

In the embodiment of FIG. 3, the cabinet has two openings, the filter 111 module is disposed at one opening, and the airflow generation module 112 is installed at the other opening. When the airflow generation module 112 is operating, an airflow is generated to flow through the filter module 111 and the accommodation space by the bottom opening, and exhausted from the upper opening. The air flows through the filter module 111 before entering the accommodation space (namely, the purification process is executed on the air), so as to prevent equipment in the accommodation space from contamination and damages, such as contamination by dust or suspended particles, or corrosion by toxic gases.

One or more air quality sensing module 101 may be disposed downstream from the filter module 111, such as at position 350, position 351 or position 352.

The cabinet may include a hub module 12. The hub module 12 may include a network hub and a power hub (not shown in figures). The network hub may be connected to the network 20 for the equipment in the cabinet to communicate with outside. The power hub may be connected to the external power supply 22, such as utility power, batteries and/or power generators, for transferring electricity (or power) to the equipment of the cabinet.

The purification control module 110 and the prediction module 100 may be connected to the hub module 12 to receive the required electricity and/or connect to the network 20.

The hub module 12 may be connected to a plurality of computer modules 23. The hub module 12 provides the electricity from the external power supply 22 to each computer module 23 and connects each computer module 23 to the network 20.

The cabinet may further include one or multiple carrying structures 34 disposed in the accommodation space, such as drawers or shelves. Each carrying structure 34 is used to accommodate and fix the computer modules 23.

The cabinet may be an outdoor cabinet with waterproof function. The cabinet body 32 may include a waterproof case, such as a waterproof cloth, a plastic case and/or a metal case, so as to prevent moisture from penetrating into the accommodation space. One or multiple splash-proof structures 30, 31, such as an eave structure, are arranged near the openings and used to prevent water from splashing into the accommodation space. The airflow generation module 112 may include a waterproof fan, such as a fan having a motor structure with waterproof coating.

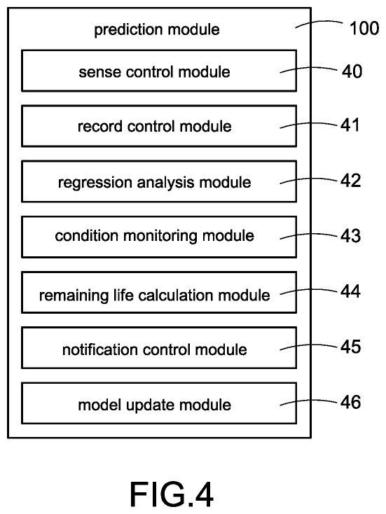

FIG. 4 illustrates an exemplary prediction module 100 including a plurality of modules 40-46 for respectively implementing different functions. The module 40-46 may be connected with each other (by electrical or information connection), and each module 40-46 may be a hardware module, such as an electronic circuit module, integrated circuit module, or a SoC, etc., a software module or a combination of hardware modules and software modules. When each of the above-mentioned modules 40-46 is a software module, such as a firmware, an operating system or an application program, the storage module 103 may include a non-transitory computer-readable medium. The non-transitory computer-readable medium stores a computer program. The computer program records a plurality of computer-executable codes. Each of the modules 40-46 may be implemented through executing the above codes by the prediction module 100 to achieve the corresponding functions.

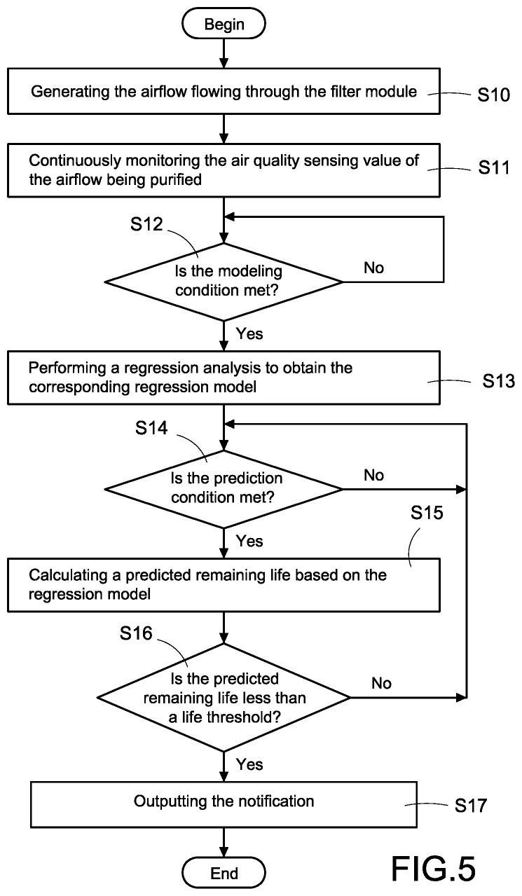

FIG. 5 illustrates an exemplary method for filter life prediction. The method of each embodiment of the disclosure may be implemented by any of the embodiments shown in FIGS. 1-4. The method of predicting filter life of this embodiment includes the following steps S10-S16.

Step S10: the purification control module 110 controls the airflow generation module 112 to generate an airflow to flow through the filter module 111 and be processed by the filter module 111. The air purification device 11 may prevent the electronic devices in the space from contaminations and achieve the cooling function by circulating the processed airflow.

Step S11: the prediction module 100 uses the sense control module 40 to continuously monitor the air quality sensing value of the processed airflow obtained by the air quality sensing module 101, and records the air quality sensing value in combination with the sensing time using the record control module 41.

The prediction module 100 may sense the air quality sensing values from a plurality of positions in the space respectively by a plurality of air quality sensing modules 101, and calculate the values to be recorded based on these air quality sensing values, such as the de-extreme value, mean value, or median value of the air quality sensing values, and so forth.

The prediction module 100 may retrieve a plurality of air quality sensing values sensed in a designated sensing time interval (such as 30 minutes, 1 hour, 1 day and so forth), and calculate the value to represent the air quality sensing value of the designated time interval based on the air quality sensing values retrieved, such as the de-extreme value, mean value, or median value of the air quality sensing values, and so forth.

Step S12: the prediction module 100 determines whether a modeling condition is met through the condition monitoring module 43. The above-mentioned modeling condition may be system default or set up manually.

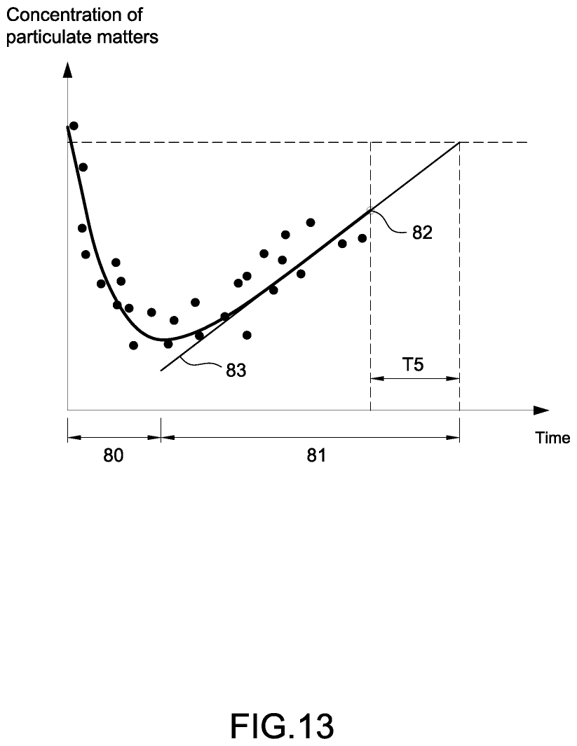

The modeling condition may include a condition that the air quality sensing value starts to decrease after the old filter is replaced with a new filter. As shown in FIG. 13, during the process of replacing the old filter, the external pollutants enter the accommodation space, such that the air quality in the accommodation space gets worse rapidly. After the replacement process of the filter module 111 is completed and the airflow generation module 112 starts to operate, the air quality in the accommodation space is gradually improved (as the air quality improvement stage 80) to the optimal status. As the use time of the filter module 111 increases, the filtration capacity of the filter module 111 gradually declines (as the air quality degradation stage 81). The disclosure is to predict the remaining life of the filter module 111 in the air quality degradation stage 81.

If the modeling condition is not met, the step S12 is performed repeatedly.

If the modeling condition is met, the step S13 is performed. The prediction module 100 performs a regression analysis through the regression analysis module 42 based on the record data of the air quality of the air purification system 1 (such as the air quality data of the accommodation space of the cabinet or of the air purification device 11) to obtain the corresponding regression model of the record data. The above-mentioned record data may include a plurality of historical air quality sensing values and the historical sensing time corresponding to each sensed value of the same filter module 111 (such as the filters of the same type or model code or the currently used filter).

The above-mentioned regression model may include at least one regression equation. The regression equation, presented in the form of a regression line, is used to express the pattern of the air quality changing with the time.

The above-mentioned regression analysis may include but not limited to a linear regression, a logarithmic regression and/or a polynomial regression. The above-mentioned regression line may correspondingly include a continuous straight line, a logarithmic curve, a continuous curve and/or other regression graphs.

The above-mentioned regression algorithms are from existing statistics, and the disclosure applies such regression algorithms to its filter life prediction method.

Since the filter module 111 may include a plurality of filters, the above-mentioned regression model may include a plurality of regression equations respectively correspond to the different filters (the filters may be the same type or different types). The prediction module 100 selects the regression algorithm suitable for the currently used filter module 111, such as linear regression, logarithmic regression or polynomial regression, to obtain the regression equation, such as linear equation, logarithmic equation, polynomial equation or the other equation, corresponding to the currently used filter.

Turn to FIG. 13, in one embodiment, the filter module 111 may include a folding filter, and the linear regression may be selected accordingly to establish the regression equation for the folding filter. The regression equation, presented as the linear regression line 83, is used to express the predicted change pattern of the air quality sensing values, which is for example the concentration of particulate matters, corresponding to the folding filter. The predicted remaining life T5 of the folding filter can be calculated through the linear regression line 83 and the newest record data point 82.

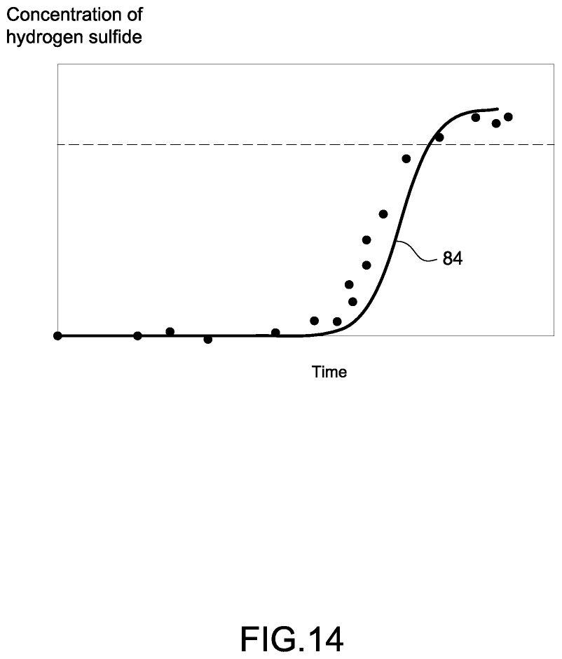

Turn to FIG. 14, in another embodiment, the filter module 111 may include a filter for filtering hydrogen sulfide, and the logarithmic regression may be selected accordingly to establish the regression equation of the filter. This regression equation, presented as the logarithmic regression line 84, is used to express the change pattern of the concentration of hydrogen sulfide with the use time corresponding to the filter.

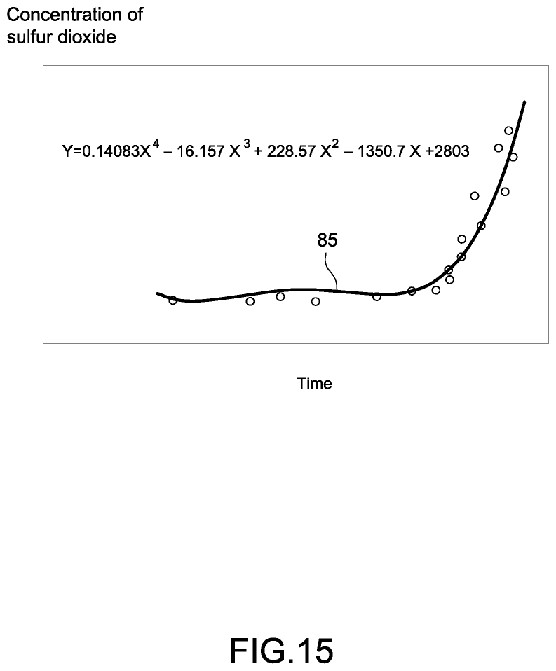

Turn to FIG. 15, in another embodiment, the filter module 111 may include a filter for filtering sulfur dioxide, and the polynomial regression may be selected to establish the regression equation (as shown in FIG. 15) of the filter. This regression equation, presented as a polynomial regression line 84, is used to express the change pattern of the concentration of sulfur dioxide with the use time corresponding to the filter.

In other words, the suitable regression algorithm may be selected based on the characteristics of declining filtration capacity of different types of filters, so as to predict the remaining life of the filter more accurately.

Back to FIG. 5, after the regression analysis of the step 13 is performed, the step S14 is then performed. The prediction module 100 determines whether the prediction condition is met through the condition monitoring module 43. The above-mentioned prediction condition may be system default or set up manually.

The prediction condition may include at least one of the following conditions: when a time interval for executing prediction (such as 30 minutes, 1 hour, 12 hours, 24 hours and so forth) expires, when the control module 2 receives a command to execute the prediction of the remaining life of the filter module (such as a command sent from the external computer 21 operated by the user), when an actual use time of the filter module reaches a time point to execute the prediction (such as the time point designated by the user), and when a difference between the air quality sensing value sensed in the previous prediction and the air quality sensing value sensed currently reaches a threshold for executing the prediction.

The step S14 is performed repeatedly if the prediction condition is not met.

Otherwise, the step S15 is performed. The prediction module 100 calculate a time period for the air quality sensing value to increase to an air quality threshold as a predicted remaining life of the currently used filter module through the remaining life calculation module 44.

Step: S16, the prediction module 100 determines whether the predicted remaining life is less than a life threshold of the currently used filter module 111 through the condition monitoring module 43. The life threshold may be system default or set up manually, and be determined based on the preparation time for replacing the filter, such as the time for purchasing the filter, the schedule arranged for replacing the filter, and/or the duration of replacing the filter.

The storage module 103 may store a plurality of life thresholds respectively corresponding to a plurality of types of filters. The prediction module 100 may select the corresponding life threshold for comparison with the predicted remaining life based on the type of the currently used filter.

The step S14 is performed again if the predicted remaining life is not less than (i.e., greater than or equal to) the life threshold.

Otherwise, the step S17 is performed. The prediction module 100 controls the output module 102 to output a notification through the notification control module 45 to notify the user to prepare the replacement of the filter.

In the related arts, whether the filter life reaches the end is determined with a fixed preset time period or through real-time detection, and users are not able to be notified accurately before the filter life reaches the end.

The disclosure can accurately predict the remaining filter life and notify the user to prepare the replacement of the filter in advance via establishing and using the regression model based on the historical record data, so as to prevent the interruption of air purification.

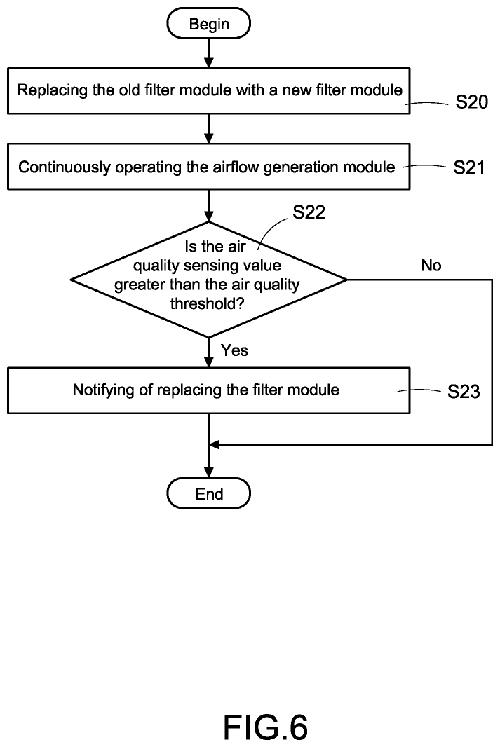

FIG. 6 illustrates an exemplary method of predicting filter life that further includes the step S20-S23 to achieve the function of detecting filter problems. The method is applied after replacing the filter module 111 and the air purification device 11 continuously operates for a period of test time (such as 1 hour, 6 hours, 12 hours, 1 day, 1 week, 1 month or other time interval which may be configured based on the air exchange rate) to detect whether the air quality is improved during this test time period (air quality improvement stage 80) to determine whether the newly installed filter module 111 (the second filter module) is suitable for the application of the environment or works normally.

Step S20: the old filter module 111 is replaced with a new filter module 111 by the user. The user may configure the prediction module 100, such as to reset the actual use time of the filter module 111.

Step S21: the prediction module 100 controls the airflow generation module 112 to continuously operate for at least the period of test time to start the ventilation in the accommodation space.

Step S22: the prediction module 100 uses the sense control module 40 to control the air quality sensing module 101 to continuously sense the air quality sensing value, and determine whether the air quality sensing value is worse (greater) than the air quality threshold after the ventilation started.

The detection is terminated if the air quality is better (lower) than the air quality threshold.

Otherwise, the step S23 is performed. The prediction module 100 uses the notification control module 45 to control the output module 102 to notify the user to replace or re-install the suitable filter module 111.

Thereby, the disclosure can effectively determine whether the type, installation method, purification capacity, etc. of the newly installed filter is suitable for the application or the filter works normally, and notify the user to replace the unsuitable filter to reduce the interruption period of air purification.

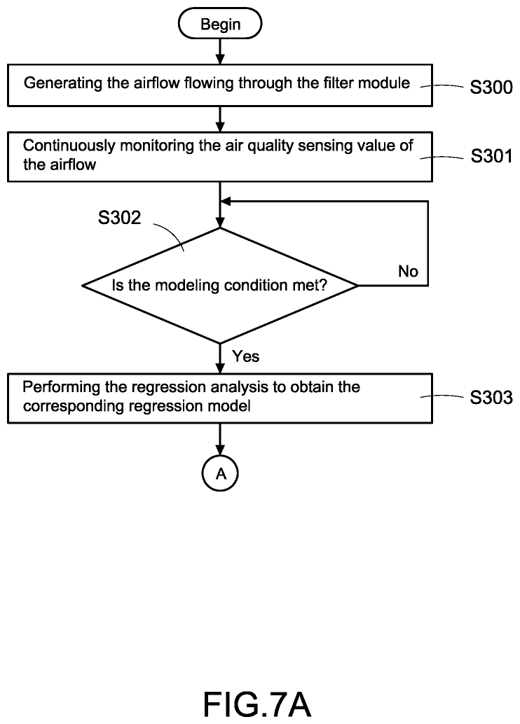

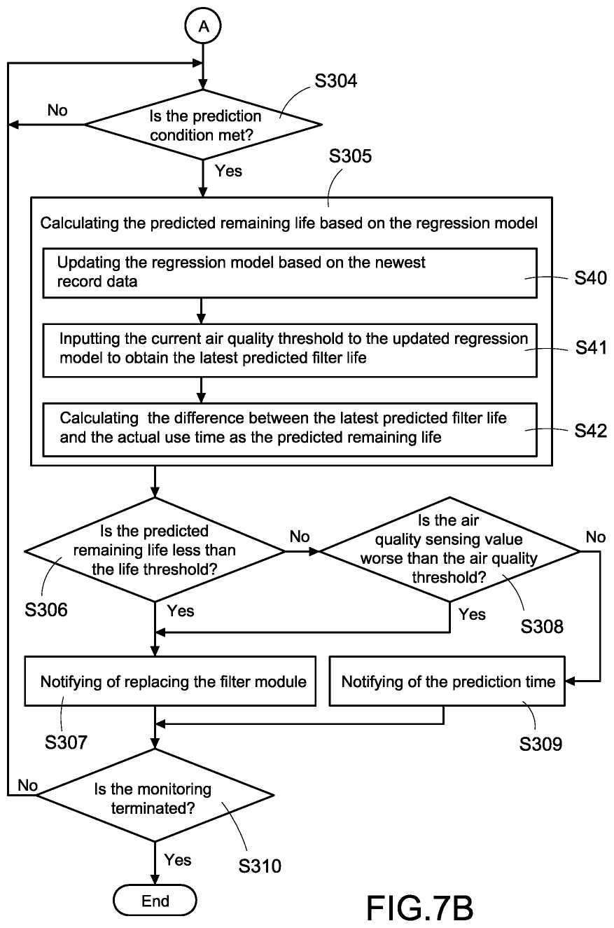

FIGS. 7A and 7B illustrate exemplary methods of predicting filter life that further provide a calculation method for accurately predicting filter life to prevent misjudgment of the filter life due to temporarily drastic changes in environmental conditions. This embodiment includes the steps S300-S310.

The steps S300-S304 is the same as or similar to the steps S10-S14, so the relevant description is omitted here for brevity.

The step S305 is performed when the prediction condition is met. The prediction module 100 uses the remaining life calculation module 44 to calculate the predicted remaining life. Step S305 may include the steps S40-S42.

Step S40: the prediction module 100 uses the model update module 46 and the regression analysis module 42 to update the regression model based on the newest record data, such as to input the newest record data to the regression analysis module 42 to generate the newest regression model before calculating the predicted remaining life.

Step S41: the prediction module 100 uses the remaining life calculation module 44 to input the current air quality threshold to the updated regression model to obtain the latest predicted filter life.

Step S42: the prediction module 100 calculates the difference between the latest predicted filter life and the actual use time (such as the operation time since activation) of the currently used filter module 111 as the predicted remaining life.

Step S306: the prediction module 100 uses the condition monitoring module 43 to determine whether the calculated predicted remaining life is less than the life threshold.

The step S307 is performed if the predicted remaining life is less than the life threshold. The prediction module 100 uses the notification control module 45 to control the output module 102 to notify the user to replace the filter module 111.

Otherwise, the step S308 is performed. The prediction module 100 uses the condition monitoring module 43 to determine whether the current air quality sensing value is worse (greater) than the air quality threshold.

The step S307 is performed if the current air quality sensing value is worse (greater) than the air quality threshold.

Otherwise, step S309 may be performed. The prediction module 100 uses the notification control module 45 to control the output module 102 to notify the user that the filter module 111 can be kept used and further notify the user of the predicted remaining life.

Step S310 is performed after the steps S307 or S309 are performed. The prediction module 100 uses the condition monitoring module 43 to determine whether the monitoring of filter life is terminated, such as whether the user turns off the filter life monitoring function.

The filter life monitoring is terminated if the determination is yes. Otherwise, step S304 is performed again to monitor the filter life continuously.

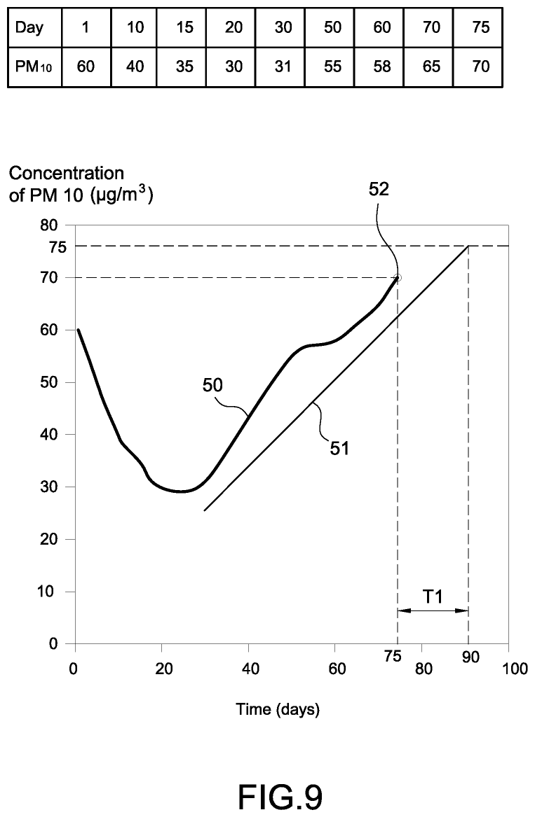

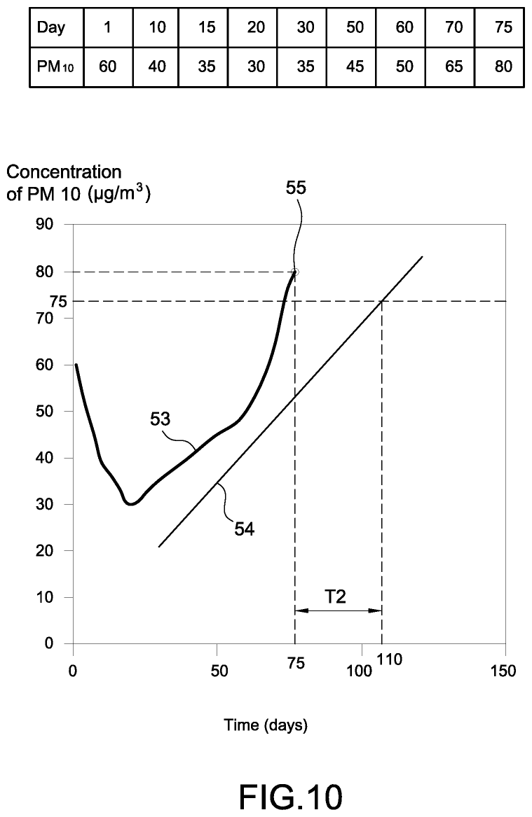

Turn to FIGS. 9 and 10, which illustrate exemplary record data regression analysis charts of the filter module using 75 μg/m³ as an example of the air quality threshold.

In FIG. 9, a regression line 51 is established based on each record data point of the newest change curve of the air quality 50. The newest record data point 52 shows that the air quality sensing value (concentration of PM 10) of the filter module 111 on the 75th day of use is 70 μg/m³.

By projecting the air quality threshold on the time axis of the regression line 51, it may be calculated that the air quality sensing value will be equal to or greater than 75 μg/m³ on the 90th day (predicted filter life), which is caused by the deterioration of the filtration capacity of the filter module 111, and the predicted remaining life T1 is 15 days (90 minus 75).

In FIG. 10, the regression line 54 is calculated based on each record data point of the newest change curve of the air quality 53. The newest record data point 55 shows that the air quality sensing value (concentration of PM 10) of the filter module 111 on the 75th day of use is 80 μg/m³.

It may be calculated that the life of the filter module 111 reaches the end on the 110th day (predicted filter life) by projecting the air quality threshold on the time axis of the regression line 54.

Although the predicted remaining life T2 is not zero (35 days which is obtained by 110 minus 75), the air quality sensing value of the record data point 55 is already greater than the air quality threshold due to the rapid deterioration of the air quality.

To solve the above problem that the rapidly changing air quality may not be applicable to the regression model, the disclosure further compares the current air quality sensing value with the air quality threshold and notifies users to replace the filter if the threshold is surpassed by the air quality sensing value for reducing the interruption period of air purification.

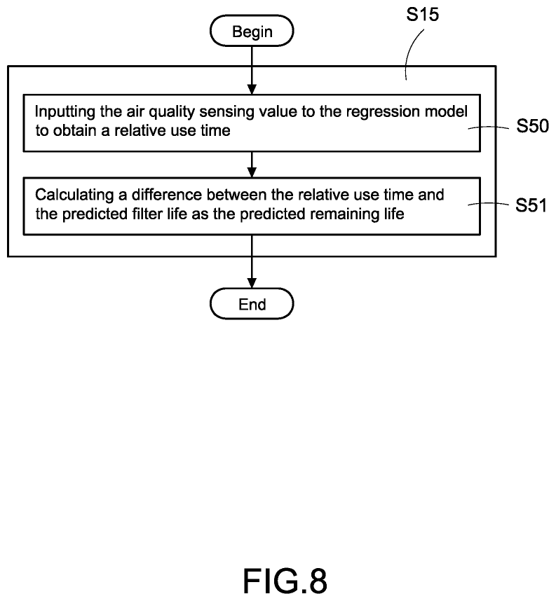

FIG. 8 illustrates another exemplary method of calculating the predicted remaining life in response to drastic changes in environmental conditions and reminding the user in advance to prepare to replace the filter when the air quality drops rapidly.

In the step S15 of this embodiment, the prediction module 100 uses the remaining life calculation module 44 to input the current air quality sensing value to the (updated) regression model to obtain a relative use time of the filter module (step S50). Namely, the relative use time expresses the use time corresponding to the degree of deterioration of the filtration capacity of the currently used filter module 111 based on the past record data. Then, the prediction module 100 calculates a difference between the relative use time and the predicted filter life that may be obtained by inputting the air quality threshold to the regression model as the predicted remaining life (step S51).

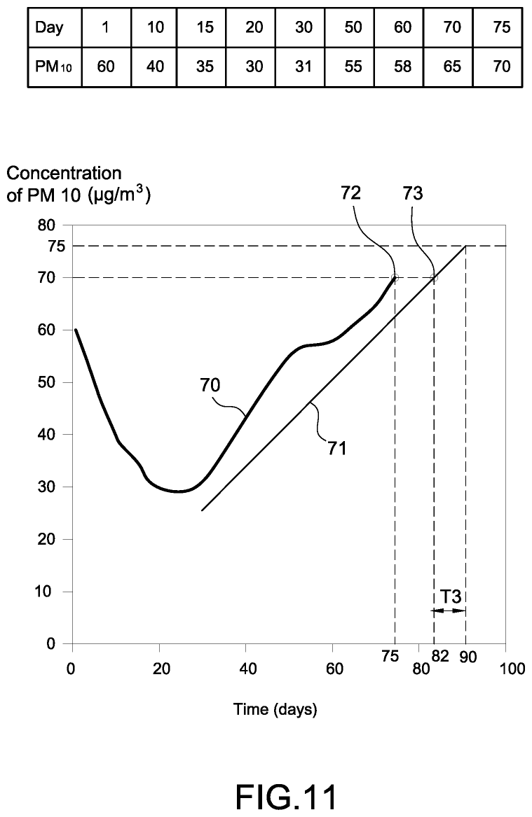

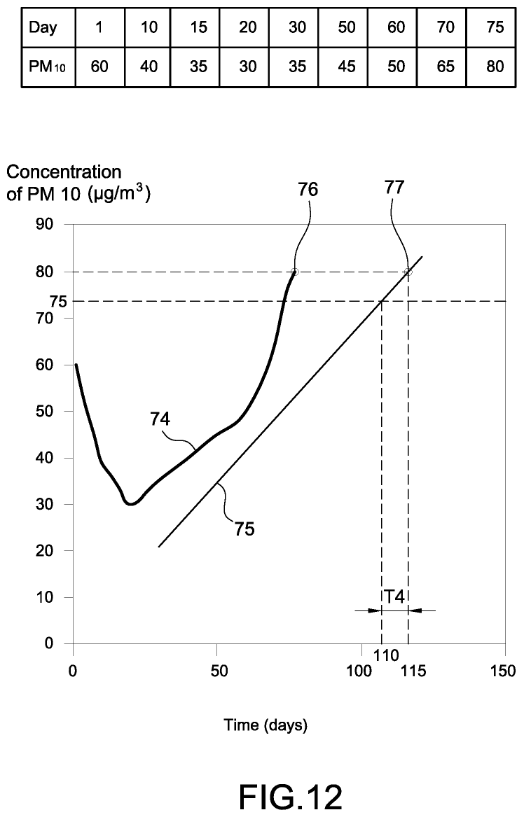

Turn to FIGS. 11 and 12, which illustrate another exemplary record data regression analysis chart of the filter module using 75 μg/m³ as an example of the air quality threshold.

The regression line 71 shown in FIG. 11 may be calculated in advance, such as when the filter module 111 is replaced and the modeling condition is met. The newest record data point 72 of the change curve of the air quality 70 shows that the air quality sensing value (concentration of PM 10) of the filter module 111 on the 75th day of use is 70 μg/m³. It may be calculated that the life of the filter module 111 may reach the end on the 90th day (predicted filter life) by projecting the air quality threshold on the time axis of the regression line 71. A relative use time of the filter module 111 can be obtain as 82 days by inputting the air quality sensing value of the newest record data point 72 (70 μg/m³) into the regression line 71. Hence, the predicted remaining life T3 may be calculated as 8 days by subtracting the relative use time from the predicted filter life (90 minus 82).

The regression line 75 shown in FIG. 12 may be calculated in advance. The newest record data point 76 of the change curve of the air quality 74 shows that the air quality sensing value of the filter module 111 on the 75th day of use is 80 μg/m³. It may be calculated that the life of the filter module 111 may reach the end on the 110th day (predicted filter life) by projecting the air quality threshold on the time axis of the regression line 75. A relative use time of the filter module 111 can be obtain as 115 days by inputting the air quality sensing value of the newest record data point 76 (80 μg/m³) into the regression line 75. Hence, the predicted remaining life T4 may be calculated as negative 5 days by subtracting the relative use time from the predicted filter life (110 minus 115).

Accordingly, with the method of this embodiment, users can be notified in time or in advance to prepare to replace the filter if the air quality drops rapidly, so as to reduce the interruption period of air purification.

What is claimed is:

1. A method of predicting filter life, comprising:
a) operating an airflow generation module to make an airflow flowing through a filter module;
b) monitoring the airflow by an air quality sensing module to obtain an air quality sensing value, and recording the air quality sensing value and a sensing time corresponding to the air quality sensing value as a record data;
c) performing, when a modeling condition is met, a regression analysis by a control module based on the record data to obtain a regression model;
d) calculating, when a prediction condition is met, a time period for the air quality sensing value to reach an air quality threshold based on the regression model as a predicted remaining life; and
e) generating a notification when the predicted remaining life is less than a life threshold.

2. The method according to claim 1, further comprising:
f) generating a notification of replacing a second filter module when the air quality sensing value is greater than the air quality threshold after the filter module is replaced to the second filter module and the airflow generation module operates for a period of test time.

3. The method according to claim 1, wherein the modeling condition comprises a condition that the air quality sensing value starts to decrease.

4. The method according to claim 1, wherein the prediction condition comprises at least one of following conditions: when a time interval for executing prediction expires, when the control module receives a command to execute prediction of a remaining life of the filter module, when an actual use time of the filter module reaches a time point to execute prediction, and when a difference between the air quality sensing value sensed previously and the air quality sensing value sensed currently reaches a threshold for executing prediction.

5. The method according to claim 1, wherein the regression model is used to express a pattern of the air quality sensing value changing with the sensing time; wherein the regression analysis comprises at least one of following regressions: a linear regression, a logarithmic regression and a polynomial regression.

6. The method according to claim 1, wherein the step d) comprises:
d1) updating the regression model based on the record data newly updated when the prediction condition is met; and
d2) inputting the air quality threshold to the updated regression model to obtain a predicted filter life, and calculating a difference between the predicted filter life and an actual use time of the filter module as the predicted remaining life.

7. The method according to claim 6, further comprising:
g1) generating a notification of the predicted remaining life when the air quality sensing value sensed currently is lower than the air quality threshold and the predicted remaining life is greater than or equal to the life threshold; and
g2) generating a notification of replacing the filter module when the air quality sensing value sensed currently is greater than the air quality threshold.

8. The method according to claim 1, wherein the step d) comprises:
d3) inputting the air quality sensing value sensed currently to the regression model to obtain a relative use time of the filter module when the prediction condition is met; and
d4) calculating a difference between the relative use time and a predicted filter life as the predicted remaining life, wherein the predicted filter life is obtained by inputting the air quality threshold to the regression model.

9. The method according to claim 1, wherein the air quality sensing value comprises a concentration of particulate matters or a concentration of airborne molecules.

10. A cabinet with filter life prediction function, the cabinet comprising:
a cabinet body comprising an accommodation space and at least one opening communicating with the accommodation space;
a filter module disposed at the opening;
an airflow generation module configured to generate an airflow flowing through the opening, the filter module, and the accommodation space;
an air quality sensing module disposed downstream from the filter module and configured to sense an air quality sensing value of the airflow; and
a control module electrically connected to the airflow generation module and the air quality sensing module and configured to control the airflow generation module,
wherein the control module is configured to record a record data comprising the air quality sensing value and a sensing time corresponding to the air quality sensing value, and perform a regression analysis based on the record data to obtain a regression model when determining a modeling condition is met, and calculate a time period for the air quality sensing value to reach an air quality threshold based on the regression model as a predicted remaining life when determining a prediction condition is met, and generate a notification when determining the predicted remaining life is less than a life threshold.

11. The cabinet according to claim 10, further comprising: an output module electrically connected to the control module and configured to output the notification;
wherein the output module comprises at least one of following modules: a display module, an audio output module and a network transmission module, wherein the network transmission module communicates with an external computer through a network;
wherein the control module is further configured to control the display module to display a notification image, or control the audio output module to play a notification audio, or control the network transmission module to transfer a notification message to the external computer;
wherein the control module is further configured to generate a notification of replacing a second filter module when determining the air quality sensing value is greater than the air quality threshold after the filter module is replaced to the second module and the airflow generation module operates for a period of test time.

12. The cabinet according to claim 10, further comprising: a storage module electrically connected to the control module and configured to store the modeling condition and the prediction condition;
wherein the modeling condition comprises a condition that the air quality sensing value starts to decrease;
wherein the prediction condition comprises at least one of following conditions: when a time interval for executing prediction expires, when the control module receives a command to execute prediction of a remaining life of the filter module, when an actual use time of the filter module reaches a time point to execute prediction, and when a difference between the air quality sensing value sensed previously and the air quality sensing value sensed currently reaches a threshold for executing prediction.

13. The cabinet according to claim 10, further comprising: a storage module electrically connected to the control module and configured to store the regression model and the record data;
wherein the control module comprises a purification control module and a prediction module, wherein the purification control module is electrically connected to and configured to control the airflow generation module, and the prediction module is electrically connected to the air quality sensing module and configured to execute filter life prediction;
wherein the regression model is used to express a pattern of the air quality sensing value changing with the sensing time;
wherein the regression analysis comprises at least one of following regressions: a linear regression, a logarithmic regression and a polynomial regression.

14. The cabinet according to claim 10, wherein the cabinet body comprises a waterproof case, and a splash-proof structure is arranged near the opening for preventing water from entering the accommodation space, and the airflow generation module is disposed on the opening and comprises a waterproof fan.

15. The cabinet according to claim 10, further comprising: a storage module electrically connected to the control module and configured to store the air quality threshold, the regression model and the record data;
wherein the control module is configured to update the regression model based on the record data newly updated, and input the air quality threshold to the updated regression model to obtain a predicted filter life, and calculate a difference between the predicted filter life and an actual use time of the filter module as the predicted remaining life.

16. The cabinet according to claim 15, wherein the control module is further configured to generate a notification of the predicted remaining life when determining that the air quality sensing value sensed currently is lower than the air quality threshold and the predicted remaining life is greater than or equal to the life threshold, and the control module is further configured to generate a notification of replacing the filter module when determining the air quality sensing value sensed currently is greater than the air quality threshold.

17. The cabinet according to claim 10, further comprising: a storage module electrically connected to the control module and configured to store the air quality threshold, the regression model and the record data;
wherein the control module is further configured to input the air quality sensing value sensed currently to the regression model to obtain a relative use time of the filter module, and calculate a difference between the relative use time and a predicted filter life as the predicted remaining life;
wherein the predicted filter life is obtained by inputting the air quality threshold to the regression model.

18. The cabinet according to claim 10, wherein the air quality sensing module comprises at least one of a particulate matter sensor and an airborne molecular sensor, and the air quality sensing value comprises at least one of a concentration of particulate matters and a concentration of airborne molecules;
wherein the filter module comprises at least one of a folding filter, an activated carbon filter, a HEPA filter and a chemical filter.

19. The cabinet according to claim 10, further comprising:
a hub module connected to a network and an external power supply, the hub module connected to a plurality of computer modules and configured to provide power from the external power supply to the computer modules, and connect the computer modules to the network; and
a plurality of carrying structures disposed in the accommodation space and the computer modules are disposed thereon.
